(19) United States
(12) Patent Application Publication
(10) Pub. No.: US 2006/0237406 A1
(43) Pub. Date: Oct. 26, 2006

(54) Method for securing a drilling process

(76) Inventors: Tilmann Schmidt-Sandte, Stuttgart (DE); Joern Ostrinsky, Gerlingen (DE)

Correspondence Address: KENYON & KENYON LLP, ONE BROADWAY, NEW YORK, NY, 10004, US

(21) Appl. No.: 10/544,533

(22) PCT Filed: Nov. 14, 2003
(86) PCT No.: PCT/DE03/03779

§ 371 Date: May 18, 2006

(30) Foreign Application Priority Data
Feb. 13, 2003 (DE) 103 05 875.3

(51) Int. Cl. B23K 26/38

(52) U.S. Cl. 219/121.71; 219/121.7; 219/121.83

(57) ABSTRACT

A method is described for process control during a drilling process, a laser drilling process in particular. While a laser beam is affecting an area of a workpiece, the measuring beam is directed onto the borehole being drilled within this area. As soon as a breakthrough has been produced in the borehole, the measuring beam is able to pass through the borehole and to be detected by a sensor. This measuring beam is detected by a sensor. It can thus be accurately determined whether and when a breakthrough occurred.

### FIELD OF THE INVENTION

The present invention relates to a method for process control during a drilling process and a corresponding device.

### BACKGROUND INFORMATION

For process control when laser drilling small boreholes having a diameter in the range below 500 μm, conventional process emissions such as the process luminescence or acoustic signals are detected using appropriate sensors, and the measuring signals are analyzed using analyzing algorithms.

A breakthrough sensor is preferably used in precision laser drilling to detect the moment of drill-through (breakthrough) of the workpiece by the laser beam on the basis of the intensity of the process luminescence. Using this data, information about the drilling process, for example, may be obtained, and required drilling times for providing the desired borehole diameter may be determined. One criterion for a breakthrough when drilling using short-pulse laser beams (e.g., ns pulses) is a steeper drop of the signal for the intensity of the process luminescence, for example.

A process luminescence generated when drilling using ultra-short-pulse laser radiation (pulse lengths in the range between a few femtoseconds and a few picoseconds) changes its measurable intensity at the time of the first breakthrough of the workpiece, but only very slightly and is therefore detectable only using relatively complex sensor devices. Therefore, the conventional breakthrough sensor is barely usable for economically justifiable breakthrough sensing in laser drilling of holes of less than 500 μm in workpieces having a thickness to be drilled through of 0.5 mm to 1 mm.

### SUMMARY

An object of the present invention is to detect the breakthrough of ultra-short-pulse laser beams in laser drilling of boreholes having diameters smaller than 500 μm in particular, thus implementing process control even in ultra-short-pulse laser drilling.

An example method according to the present invention is used for process control during a drilling process, preferably a laser drilling process. When carrying out drilling processes of this type, a borehole is produced in a workpiece to be machined by a laser drilling device. To carry out the process according to the example embodiment of the present invention, a source for generating a measuring beam and a sensor for detecting this measuring beam are also used. According to the present invention, the workpiece, the source, and the sensor are situated with respect to one another in such a way that the measuring beam is not detected until a breakthrough has been produced in the borehole.

As long as no breakthrough has been produced in the workpiece to be machined, the workpiece represents a barrier for the measuring beam on its path between the source and sensor. As soon as a breakthrough has been produced, the measuring beam generated by the source is able to pass through the borehole and thus the workpiece and be detected by the sensor. This allows unambiguous information about the existence of a breakthrough in the borehole within a workpiece to be obtained in a particularly simple manner.

In carrying out the method according to the present invention, the measuring beam is preferably directed parallel to the borehole axis. This ensures that the measuring beam is able entirely to pass through the borehole as soon as the workpiece has been drilled fully through.

In another preferred embodiment, the laser beam and the measuring beam are directed along the same beam path at least in some segments, in the area of the borehole in particular. The occurrence of a breakthrough is detected in a particularly precise manner due to the measuring beam and the laser beam being conducted over the same path.

In another example embodiment of the present invention, the laser beam and the measuring beam may be conducted over the same beam path in the same direction or in opposite directions. This makes it possible, for example, to situate the measuring beam source and the drilling device on the same side or on opposite sides of the workpiece to be machined, which permits the available space to be optimally used.

In particular, according to the present invention, the laser beam and the measuring beam may be conducted largely simultaneously along an identical beam path. Due to this particularly advantageous embodiment, the drilling process, the laser drilling process in particular, may be monitored in a particularly efficient manner. The sensor used herein senses the measuring beam generally in real time, i.e., in the instance when the laser beam produced the breakthrough. This permits the exact moment of the breakthrough to be documented. This measure offers the option, for example, of turning off the laser beam in the moment of the breakthrough by using a suitable interconnection between the sensor and the laser beam.

In a preferred embodiment, the laser beam and the measuring beam have different wavelengths. In this way the sensor is prevented, in a simple manner, from confusing the measuring beam with the laser beam.

The frequency of the measuring beam may be advantageously selected in such a way that it is outside a frequency range in which the process luminescence generated during drilling is emitted. In this way the sensor is prevented from confusing the process luminescence with the measuring beam.

The method may be used in particular when the laser beam is an ultra-short-pulse laser beam. Ultra-short-pulse laser beams have pulse lengths on an order of magnitude of a few femtoseconds to a few picoseconds.

The sensor according to the present invention may be designed as a spectrometer or it may include multiple sensors, signals of predefined frequencies being detectable by the sensor. The sensor is preferably tuned or calibrated to the frequencies of the measuring beam, i.e., the measuring signal. It preferably does not respond to the frequency of the laser beam used or the frequencies of the process luminescence generated during the drilling process.

Furthermore, optical elements, such as mirrors or other optical elements, may be situated along the beam paths of the laser beam and the measuring beam.

According to the present invention, the path or the direction of the beams, i.e., the laser beam and the measuring beam, may be advantageously influenced. Optical elements that may be provided here include, for example, mirrors which reflect or deflect both the measuring beam and the laser beam, and/or mirrors which reflect or deflect one of the beams, preferably the laser beam, but are transparent to the other beam, preferably the measuring beam. Furthermore, optical elements which reflect, deflect, or transmit one of the beams, preferably the measuring beam, and absorb the other beam, preferably the laser beam, may be provided. By suitably placing these optical elements, the beam paths of the measuring beam and the laser beam may be conducted parallel to one another or they may be separated by deflection. This ensures that the measuring beam passes through the borehole at least once, and only the measuring beam reaches the sensor and is detected thereby. As an advantageous side effect, such measures may protect the sensor from damaging or dangerous laser radiation.

The measuring beam advantageously used according to the present invention passes through the borehole and is detected using a suitable sensor. On the basis of the measured intensity or amount of energy of the measuring beam, it may be determined whether or when the breakthrough of the borehole occurred. In particular, the order of magnitude of the narrowest diameter of the borehole may be quantitatively evaluated. Even when drilling using ultra-short pulses (pulse lengths in the range of fs to ps), the breakthrough is determinable reliably and in real time. The progress of the drilling may be evaluated online. Microboreholes of the highest precision and controlled conicity may be produced using ultra-short-pulse laser drilling. It is to be pointed out (as an example only) that such microboreholes are used, for example, as injection boreholes for diesel nozzles or injectors.

Manufacturing processes may be optimized using process control of this type. Furthermore, the reject rate may also be advantageously influenced.

### BRIEF DESCRIPTION OF THE DRAWINGS

The present invention is elucidated in detail with reference to the Figures.

FIGS. 1a through 1c show a schematic side view of preferred embodiments of an example device according to the present invention.

FIG. 2 shows a diagram of the acceptable intensity signals according to the present invention.

FIG. 3 shows another diagram of further acceptable intensity signals according to the present invention.

FIG. 4 shows a diagram for exemplary illustration of the relationship between the acceptable intensity signals and the borehole sizes present in each case.

### DETAILED DESCRIPTION OF EXAMPLE EMBODIMENTS

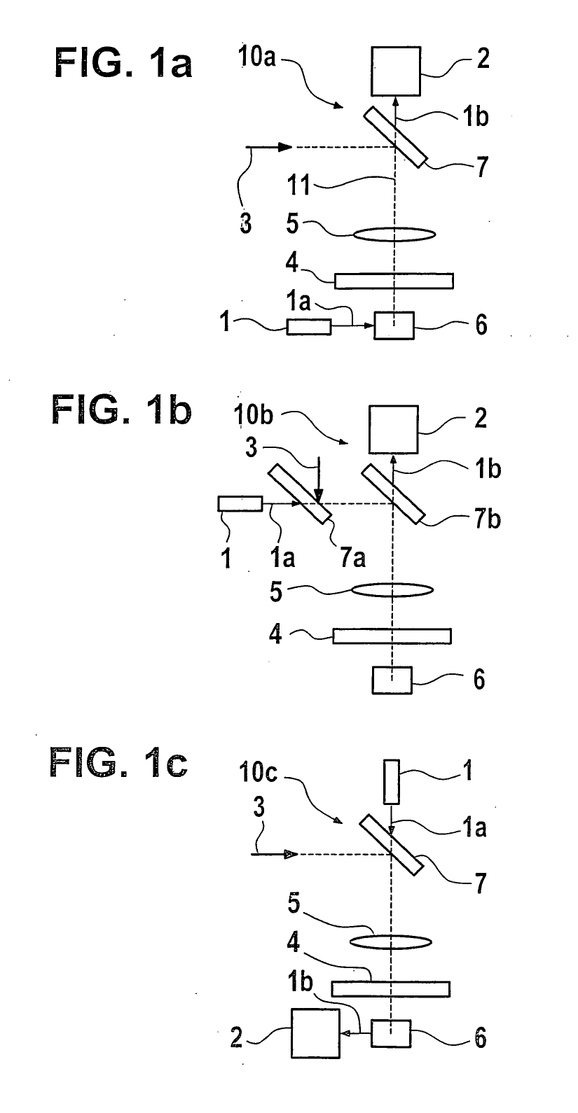

FIGS. 1a through 1c show a schematically simplified side view of alternative embodiments of the device according to the present invention. A laser beam 3 is conducted onto a workpiece 4 via a mirror 7 and lens system 5. The object here is to drill through workpiece 4.

A source 1 emits a measuring beam 1a. The wavelength of measuring beam 1a is not the same as that of laser beam 3, but is ideally in a frequency range in which a process luminescence generated during drilling is not emitted or is only minimally emitted. A sensor 2 includes, in addition to the actual sensor element, optical elements for conducting measuring beam 1a. Sensor 2 may be designed as a spectrometer or it may include multiple individual sensors which detect signals of predetermined frequencies.

In the example embodiment illustrated in FIG. 1a, laser beam 3 is directed onto workpiece 4 to be machined via deflecting mirror 7 (in the direction of the drawing) downward via lens system 5. Measuring beam 1a generated by source 1 hits workpiece 4 from below after being suitably deflected in a lens system 6, laser beam 3 and measuring beam 1a running in opposite directions along the same axis 11. The use of lens system 6 has the function of deflecting measuring beam 1a to the bottom of the workpiece and protecting source 1 from laser beam 3, after it has drilled fully through workpiece 4.

After laser beam 3 drills through workpiece 4, measuring beam 1a passes through the thus produced borehole and hits sensor 2 in the opposite direction from laser beam 3 through lens system 5 and deflecting mirror 7, which is transparent, i.e., transmissive, for the frequency of measuring beam 1a.

Measuring beam 1a is detected by sensor 2 as measuring signal 1b.

In the example embodiment shown in FIG. 1b, measuring beam 1a is superimposed on laser beam 3 in an optical element 7a, so that laser beam 3 and measuring beam 1a hit workpiece 4 after deflection by mirror 7b and passage through lens system 5 in the same direction. As soon as laser 3 breaks through, both beams pass through the borehole and reach a lens system 6, which absorbs or transmits laser beam 3 and reflects measuring beam 1a. After measuring beam 1a passes through the borehole again due to this reflection, it is transmitted by mirror 7b and detected by sensor 2 as measuring signal 1b. Mirror 7b is advantageously semi-transparent with regard to measuring beam 1a, so that part of the intensity of the measuring beam exiting source 1, together with laser beam 3, is reflected at workpiece 4 and then at lens system 6, part of the intensity of measuring beam 1a reflected at lens system 6 passing through mirror 7b to reach sensor 2.

In the variant shown in FIG. 1c of the device according to the present invention, laser beam 3 is reflected or deflected at a mirror 7. Measuring beam 1a, whose source 1 is situated above mirror 7 in this case, passes through mirror 7 without being deflected. The two superimposed beams hit workpiece 4 in the same direction. After laser beam 3 drills through workpiece 4, measuring beam 1a is deflected by lens system 6 to sensor 2 and detected as measuring signal 1b. Laser beam 3 is transmitted or absorbed by lens system 6.

Sensor 2 measures the amount of energy or intensity of incident measuring beam 1a, i.e., measuring signal 1b. The intensity of measuring beam 1a is adjusted in such a way that sensor 2 does not overdrive for the largest possible borehole. When drilling is started, no portion of measuring beam 1a is able to hit sensor 2, because the borehole has not yet been drilled through. Occasionally, the process luminescence is also emitted at a frequency of measuring beam 1a, so that the starting signal of sensor 2 is not equal to zero. As soon as a breakthrough is produced in the borehole, portions of measuring beam 1a hit sensor 2 and are detected as measuring signal 1b.

In the three illustrated embodiments, sensor 2 is unable to detect measuring signal 1b until measuring beam 1a is able to propagate unimpeded through the borehole. The progress of laser drilling over time may thus be reliably monitored.

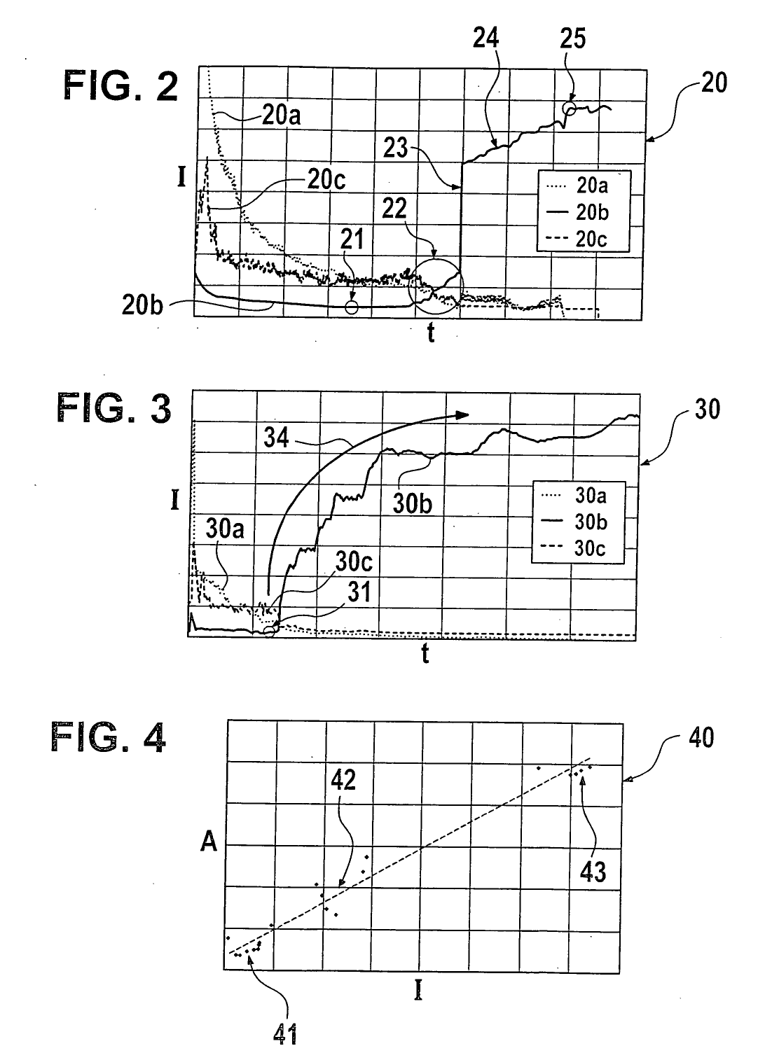

In diagrams 20, 30 shown in FIGS. 2 and 3, intensity I of the radiation is plotted over time t. The following curves are shown in diagrams 20, 30: Curves 20a, 30a (dotted) result from the intensity of the plasma radiation; curves 20b, 30b (solid) result from the intensities of the measuring radiation, and curves 20c, 30c (dashed) result from the intensity of the laser beam.

Diagram 20 of FIG. 2 shows curves 20a, 20b, 20c resulting from a large borehole having a drilling core (diameter approx. 300 μm). When twist drilling large diameters, the first breakthroughs (section 21 of curve 20a) may close up again, and there may be multiple breakthroughs (section 22) over the extent of the borehole. Therefore, the intensity of the measuring beam (curve 20b) increases only slightly starting with the first breakthroughs (section 21), which may close up again as mentioned above. In contrast, if the drilling core drops out (section 23), the intensity of the measuring beam (curve 20a) increases suddenly and is detectable in a particularly simple manner. As drilling progresses, the diameter of the borehole is enlarged (section 24). If the signal of the measuring beam remains constant, the borehole has reached its final diameter (section 25).

In diagram 30 shown in FIG. 3, curves 30a, 30b, 30c are shown when a small hole is drilled without a drilling core (diameter approx. 100 μm). Compared to the diagram of FIG. 2, in this example the breakthrough surface area is much larger than the total borehole surface area, so that the intensity of the measuring signal (curve 30b) increases more significantly with the first breakthrough (section 31). If the drilling process is continued after the first breakthrough (section 31), the borehole widens (curved arrow 34) and the intensity of the measuring beam (curve 30b) further increases.

In diagram 40 of FIG. 4, the axis of surface area A of the borehole in μm² is plotted over axis I of the intensity signal of the measuring beam. Measurement points 41 result from boreholes having diameters smaller than 100 μm, measurement points 42 from boreholes of medium-sized diameters, and measurement points 43 from boreholes of larger diameters (between 250 μm and 350 μm). The intensity of the measuring signal is a function of the amount of radiation passing through the borehole and therefore of the surface area of the narrowest diameter of the borehole. Interfering quantities for the signal include the shielding effect of a possible plasma (in the borehole), intensity fluctuations of the measuring beam source, bending and reflection effects in the borehole.

1-11. (canceled)

12. A method for process control during a laser drilling process, comprising:
producing a borehole using a laser beam generated by a laser, in a workpiece to be machined;
providing a source for generating a measuring beam and directing the measuring beam onto the workpiece;
providing a sensor for detecting the measuring beam; and
situating the workpiece, the source, and the sensor with respect to one another in such a way that the measuring beam is not detected until a breakthrough has been produced in the borehole.

13. The method as recited in claim 14, wherein the measuring beam is directed onto the borehole parallel to an axis of the borehole.

14. The method as recited in claim 12, wherein the laser beam and the measuring beam are conducted along a same beam path at least in some segments.

15. The method as recited in claim 14, wherein the laser beam and the measuring beam are conducted along the same beam path in an area of the borehole.

16. The method as recited in claim 12, wherein the laser beam and the measuring beam are conducted along a same beam path in a same direction or in opposite directions.

17. The method as recited in claim 12, wherein the laser beam and the measuring beam are conducted largely simultaneously along an identical beam path.

18. The method as recited in claim 12, wherein the laser beam and the measuring beam have different wavelengths.

19. The method as recited in claim 12, wherein a frequency of the measuring beam is selected to be outside a frequency range in which process luminescence generated during drilling is emitted.

20. The method as recited in claim 12, wherein the laser beam is an ultra-short-pulse laser beam having a preferred pulse length on the order of magnitude of a few femtoseconds to a few picoseconds.

21. A device for process control during a laser drilling process in which a borehole is produced in a workpiece to be machined using a drilling, a laser beam generated by a laser, comprising:
a source to generate a measuring beam; and
a sensor to detect the measuring beam;
wherein the workpiece, the source, and the sensor are able to be arranged relative to one another in such a way that the measuring beam is not detected until a breakthrough has been produced in the borehole.

22. The device as recited in claim 21, wherein the sensor is a spectrometer or includes multiple sensors, signals of predefined frequency being detectable by the sensor.

23. The device as recited in claim 21, further comprising:
optical elements situated along beam paths of the laser beam and the measuring beam.

24. The device as recited in claim 23, wherein the optical element includes at least one of mirrors or a lens system.
